(19) United States
(12) Patent Application Publication
(10) Pub. No.: US 2018/0270183 A1
(43) Pub. Date: Sep. 20, 2018

(54) METHODS AND APPARATUSES FOR SELECTIVELY DISPLAYING MESSAGES BASED ON A PREDICTED IMPORTANCE

(71) Applicant: Alibaba Group Holding Limited, Grand Cayman (KY)

(72) Inventor: Quanyun WEI, Hangzhou (CN)

(21) Appl. No.: 15/916,577

(22) Filed: Mar. 9, 2018

(30) Foreign Application Priority Data
Mar. 15, 2017 (CN) 201710154488.7

(51) Int. Cl. H04L 12/58; G06F 3/0484

(52) U.S. Cl. CPC H04L 51/26; G06F 3/0484; H04L 51/24

(57) ABSTRACT

Disclosed in the embodiments of the disclosure are message prompting and display methods and a related apparatuses. When a group conversation interface is active, if an unread message exists among the received messages sent to a user, a message prompt indicator may be displayed on the group conversation interface. When intending to view the unread message, the user may perform an expansion operation on the message prompt indicator, and the instant messaging tool will directly expand a message viewing area within a partial area of the group conversation interface and display the unread message unread to the user in the message viewing area. Because the message viewing area and the group conversation interface are displayed at the same time, the user does not have to leave the current group conversation interface when viewing the message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

### CROSS-REFERENCE TO RELATED APPLICATIONS

This application claims the benefit of priority of Chinese Application No. 201710154488.7, titled “A METHOD FOR MESSAGE NOTIFICATION, A METHOD AND APPARATUS FOR MESSAGE DISPLAY,” filed on Mar. 15, 2017, which is hereby incorporated by reference in its entirety.

### BACKGROUND

### Technical Field

The disclosed embodiments relate to the field of digital messaging, and in particular, to automatically detecting high importance messages and providing a separate viewing area for such messages.

### Description of the Related Art

With the development of network technologies, it is a common communication technique to install instant messaging tools on smart terminals for communication. For example, users can use DINGTALK (an instant messaging tool), to instantly send messages to one another. The process in which a user uses an instant messaging tool to interact with another user using the instant messaging tool is referred to as a conversation.

When a user is using the instant messaging tool to have a conversation with another user (e.g., via a conversation interface of the tool), if another user sends a message related to the user at a given moment, current systems display a prompt that is provided in a notification bar of the smart terminal to prompt the user.

When the user intends to read the message immediately, the user can expand the notification bar first and then tap on the prompt for the message in the notification bar. The user will then be taken to a conversation interface including the message corresponding to the prompt. This method of reading a message requires the user to leave the original conversation interface. Specifically, when the viewed message is not important, the user will need to switch back to the original conversation interface to continue with the previous conversation. Thus, in current conventional message systems, a user needs to leave a current conversation interface if they wish to read an unread message. This results in a poor user experience.

In another scenario, a user logs into an instant messaging tool and an active conversation interface fails to present all unread messages. The user may then intend to read other unread messages resulting in the user leaving the current conversation interface or scrolling up on the current conversation interface to view the unread messages. Therefore, in current conventional message systems, a user must exit the current conversation interface or hide the message content currently displayed on the conversation interface if he intends to read an unread message. This also results in a poor user experience.

Some of the messages sent to a user, such as those including important information or those that are more of interests to the user, are more important than others. Usually, the user is more willing to view the important messages than ordinary messages. However, when numerous messages are sent to the user, in order not to miss important messages, the user needs to browse a large amount of information by going through them individually. This leads to low efficiency and a poor user experience.

### SUMMARY

To resolve the above technical problems, the disclosed embodiments provide message prompting methods, message displaying methods, and related apparatuses. With the message prompting methods, the message displaying methods, and the related apparatuses, a user does not need to switch conversation interfaces, and will not miss messages being currently exchanged on a group conversation interface, thereby improving user experience.

In one embodiment, a method is disclosed comprising receiving, at a client device, messages for display on an instant messaging tool; displaying, on the client device, the messages in a conversation interface of the instant messaging tool; identifying, by the client device, an important message in the messages; displaying, by the client device, a message prompt indicator in response to detecting the important message; expanding, by the client device, a message viewing area in a partial area of the instant messaging tool in response to detecting an operation executed on the message prompt indicator; and displaying, by the client device, the important message in the message viewing area.

In another embodiment, an apparatus is disclosed comprising: a processor; and a storage medium for tangibly storing thereon program logic for execution by the processor, the stored program logic comprising: logic, executed by the processor, for receiving messages for display on an instant messaging tool; logic, executed by the processor, for displaying the messages in a conversation interface of the instant messaging tool; logic, executed by the processor, for identifying an important message in the messages; logic, executed by the processor, for displaying a message prompt indicator in response to detecting the important message; logic, executed by the processor, for expanding a message viewing area in a partial area of the instant messaging tool in response to detecting an operation executed on the message prompt indicator; and logic, executed by the processor, for displaying the important message in the message viewing area.

It can be seen from the above technical solutions that when a group conversation interface is active if an unread message exists among the received messages sent to a user, a message prompt indicator may be displayed on the group conversation interface. When intending to view the unread message, the user may perform an expansion operation on the message prompt indicator, and the instant messaging tool will directly expand a message viewing area within a partial area of the group conversation interface and display the unread message unread to the user in the message viewing area. Because the message viewing area and the group conversation interface are displayed at the same time, the user does not have to leave the current group conversation interface when viewing the message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

### BRIEF DESCRIPTION OF THE DRAWINGS

To more clearly illustrate the technical solutions in embodiments of the disclosure or in the prior art, the drawings which need to be used in the description of the embodiments or the prior art will be introduced briefly in the following section. The drawings described below are merely some embodiments of the disclosure, and those of ordinary skill in the art can also obtain other drawings according to these drawings without making creative efforts.

FIG. 1 is a flow diagram illustrating a message displaying method according some embodiments of the disclosure.

FIG. 2 is a user interface diagram illustrating a message prompt indicator on a group conversation interface according to some embodiments of the disclosure.

FIG. 3A is a user interface diagram illustrating an expanded message viewing area on a group conversation interface according to some embodiments of the disclosure.

FIG. 3B is a user interface diagram illustrating an expanded message viewing area on a group conversation interface according to some embodiments of the disclosure.

FIG. 4 is a user interface diagram illustrating the structure of a message viewing area according to some embodiments of the disclosure.

FIG. 5 is a flow diagram illustrating a message displaying method according to some embodiments of the disclosure.

FIG. 6 is a flow diagram illustrating a message prompting method according to some embodiments of the disclosure.

FIG. 7 is a block diagram illustrating a server according to some embodiments of the disclosure.

FIG. 8 is a block diagram illustrating a message displaying apparatus according to some embodiments of the disclosure.

FIG. 9 is a block diagram illustrating a message displaying apparatus according to some embodiments of the disclosure.

FIG. 10 is a block diagram illustrating a message prompting apparatus according to some embodiments of the disclosure.

FIG. 11 is a block diagram illustrating a message prompting system according to some embodiments of the disclosure.

FIG. 12 is a flow diagram illustrating a message prompting method according to some embodiments of the disclosure.

FIG. 13 is a block diagram illustrating a message prompting apparatus according to some embodiments of the disclosure.

### DETAILED DESCRIPTION

The disclosed embodiments are described below with reference to the accompanying drawings.

At present, it is very common for users to exchange messages by using instant messaging tools configured on smart terminals. A user can interact with other users added as friends in an instant messaging tool, and a user can also join a group consisting of a plurality of users and interact with users within the group. When a user joins many groups or adds a large number of friends in the instant messaging tool, it is quite likely that when the user is chatting with other people or having a group chat, another user or group sends messages to the user at the same time. However, the messages sent at this point cannot be displayed on the current conversation interface. Therefore, in this case, the user needs to switch conversation interfaces if he or she wants to view these messages; and switching conversation interface can be a complex operation.

In another case, a user might have just logged into an instant messaging tool and have received numerous messages. For example, a large number of exchanged messages may have been generated in a group before the user logs in, and these messages are unread messages for the user. When the user is a conversation interface with unread messages, there might be so many unread messages on the current conversation interface that the messages cannot be displayed fully on the current conversation interface. Therefore, the user further needs to scroll through the messages on the conversation interface to view unread messages generated earlier. Although this manner does not require switching conversation interfaces, the user needs to use the current conversation interface to view earlier generated messages, and the user might miss messages being currently exchanged on the group conversation interface, which also suggests that the user is highly likely to miss important messages.

In short, in either case, the conventional message viewing methods do not provide a desirable user experience. In view of this, the embodiments of the disclosure provide message prompting methods, message displaying methods, and related apparatuses. When a group conversation interface is active, if an unread message exists among the received messages sent to a user, a message prompt indicator may be displayed on the group conversation interface. When intending to view the unread message, the user may perform an expansion operation on the message prompt indicator, and the instant messaging tool will directly expand a message viewing area within a partial area of the group conversation interface and display the unread message unread to the user in the message viewing area. Because the message viewing area and the group conversation interface are displayed at the same time, the user does not have to leave the current group conversation interface when viewing the message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

The solutions provided by the embodiments of the disclosure may apply to an instant messaging tool configured on a smart terminal, so that a desired message viewing function may be implemented by using the instant messaging tool. The smart terminal may be a terminal having an instant messaging tool capability provided such as a smartphone, a personal digital assistant (PDA), or a personal computer. The instant messaging tool may be software or an application that has a real-time message exchange function such as DINGTALK.

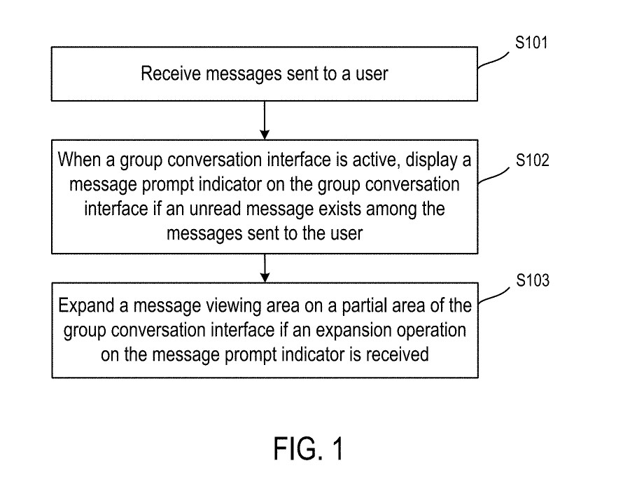

FIG. 1 is a flow diagram illustrating a message displaying method according to some embodiments of the disclosure.

S101: Receive messages sent to a user, wherein the user is a user logging into the instant messaging tool on a client device, such as a smart terminal.

It some embodiments step S101 may be performed before or after S102 or S103. The messages sent to the user received in S101 may include messages that have been received before the user logs into the instant messaging tool. They may also include messages received when the user is using the instant messaging tool and when the group conversation interface is active. They may also include messages received when a message viewing area is expanded.

The illustrated embodiment primarily focuses on messages sent to the user. The messages sent to the user may comprise messages that need to be viewed by the user, or messages having content the user needs to read, which may be considered as messages related to this user.

The way a message is sent, or a message recipient, may be used as a basis for confirmation to determine which messages or message are/is messages/message sent to the user from a large number of messages. For example, for messages sent to the user separately by other users or a system, a recipient of such messages is only the user, and the messages obviously include content intended to be read by the user. Such messages may comprise messages sent to the user. As another example, for a message that is sent to a group including the user, the message sent to the group is intended to be received by the user, and the message may comprise a message sent to the user. For a group conversation, a message sent to this group may comprise a message sent to all users in the group; and the message is sent to a specific user in the group, such as the user in “the messages sent to the user” mentioned in this embodiment.

In addition to enabling efficient and convenient viewing of messages, the methods provided by this embodiment also allow the user to view important messages related to the user in a more precise manner. Important messages herein are messages that the user needs to view or messages that include content that the user needs to read. Additionally, important messages herein are more highly expected to be viewed by the user, and the content carried therein is also more important. For example, in a group, because everyone can send a message, a large number of messages usually exist. If the messages include an important message related to a user A, the message is quite likely to be located in the large number of messages. If the user A intends to view the message, the user A may need to manually browse through the large number of messages of the group to find the important message. This is not a pleasant experience for the user A; and sometimes a user in this case even cannot find the important message, resulting in unnecessary loss of time and information.

The illustrated embodiments provide a method for determining whether a message sent to a user is an important message. After messages sent to the user are received, the method can be used to determine whether the messages sent to the user meet a pre-set condition. If so, the method determines that the messages sent to the user are important messages, in which case S102 may be performed subsequently. If not, the method determines that the messages sent to the user are not important messages, in which case the user will not be prompted. An example of prompting is to display a message prompt identifier on the group conversation interface.

When it is determined that the messages are important, the messages need to meet the pre-set condition, and the pre-set condition may be determined according to a pre-set rule. The pre-set rule may be defined by a developer according to the requirement of the user in advance, or the pre-set rule may be concluded via machine learning or artificial intelligence self-learning. Machine learning and artificial intelligence recommendation may be optimized based on feedback from the user. The pre-set condition may include a combination of any one or more of the following: the content of the messages including specific linguistic data; the content of the messages being related to content of a historical message sent by the user; the content of the messages comprising an identifier of the user, a sender of the messages, and the user meeting a predetermined relationship, and the messages satisfy a pre-set rule.

For example, in a group, if a user A would like a sent message to be seen by a user B, the user A may add to this message a pointer to the user B according to a pre-set condition (for example, by adding “@user B” into the message to point this message to the user B). Although this message is also visible to others in the group, the message is obviously more important to the user B than to other users in the group, and it is a message intended to be viewed by the user B specifically. Therefore, this message is determined to be an important message related to the user B by satisfying the pre-set condition of “@user B” under the pre-set rule of “@”.

In addition to such a pre-set rule commonly used in groups, the pre-set condition may be that a sender of a message meets a predetermined relationship with the user. For example, the predetermined relationship may be that the sender is a manager of the user at work. When the user is a user C, if the manager of the user C sends a message in a workgroup, since the sender is the manager who satisfies the predetermined relationship with the user C, the message can be determined to be an important message related to the user C in the workgroup.

The pre-set condition may be further set as including a special character or having a special format. When a character included in the message or the format of a message sent by user A to user B satisfies the pre-set condition, the message may be determined to be an important message related to user B.

The pre-set condition may further include that the content of a message includes specific linguistic data, and the specific linguistic data may be words or numbers. For example, the specific linguistic data may be a keyword or a key figure that the user pays attention to. When a message sent to the user includes the specific linguistic data, the message will be determined to be an important message belonging to the user. The specific linguistic data may be related to a hobby of the user or reflect the hobby of the user. The specific linguistic data may be set by the user or may be generated by a machine according to network behaviors of the user.

For example, there might be 100 users in a group, among which 20 users set up a hobby-related label for themselves as “soccer.” If a user in this group sends a message with the content “Kicking balls this afternoon?”, by learning associations with the machine, a system can determine that “kicking balls,” and “soccer” are relevant. That is, “kicking balls” may be considered as specific linguistic data related to the 20 users with the label “soccer”; the message will be determined to be an important message to the 20 users, and a prompt will be sent when anyone in the 20 users has not read this message.

For another example, if a user in a group follows news like “fine cuisine,” the system may consider that the user is fond of delicious food, and may set linguistic data related to fine cuisine as specific linguistic data related to the user. When the content of a message sent by a user to this specific user includes fine cuisine-related content such as “the sliced fish in hot chili oil at the restaurant xx is very delicious,” the phrase “sliced fish in hot chili oil” may be identified as specific linguistic data related to the user. The message may then be determined to be an important message to the user. If the user has not read this message, the user may be prompted.

The pre-set condition may further include that the content of a message includes an identifier of the user. The identifier of the user may be content that can be used to identify the user, such as a username, a real name, and a job number of the user. When a message sent to the user includes the identifier of the user, the message will be determined to be an important message to the user.

The pre-set condition may further include that the content of a message is related to the content of a historical message sent by the user. Whether a message sent to the user is related to a message previously sent by the user may be identified using machine learning or automatic artificial intelligence (AI) determination. For example, the message being a reply to the message previously sent by the user or the message referring to the content of the message previously sent by the user may be determined to be related to the content of a historical message sent by the user. To improve computational efficiency, a historical message may be defined by using a time range. For example, messages sent by the user in a recent period may be defined as historical messages sent by the user. Alternatively, historical messages may be defined by the number of sent messages. For example, N messages recently sent by the user are defined as historical messages sent by the user.

S102: When a group conversation interface is active, display a message prompt indicator on the group conversation interface if an unread message exists among the messages sent to the user.

For example, a conversation may comprise a process of exchanging messages among users. A conversation interface may comprise an interface or a window for displaying messages or content exchanged in the conversation among the users. In this embodiment, the group conversation interface is an interface for conversations between the user and a plurality of other users. The group conversation interface may be a conversation interface for a group conversation or a group chat window between the user and a group including a plurality of users.

In general, messages displayed by the instant messaging tool with the conversation interface may be regarded as already viewed messages. That is, the messages are considered to have been read by the user. An unread message may comprise a message that has not been displayed on the conversation interface. That is, the message is considered not have been read by the user.

Because there may be a plurality of conversations from which the messages are sent to the user, obviously not all the messages can be displayed on the group conversation interface. Therefore, when the group conversation interface is active, some or all of the messages sent to the user are not displayed to the user, leading to some unread message. Or, even if all the messages sent to the user belong to the conversation corresponding to the group conversation interface, the number of messages being displayed simultaneously in the target conversation window is limited. This is because the size of a target conversation window is limited; for example, the maximum size is the area of the display interface of the smart terminal. Therefore, messages in the messages sent to the user that have not been displayed on the current group conversation interface are unread messages.

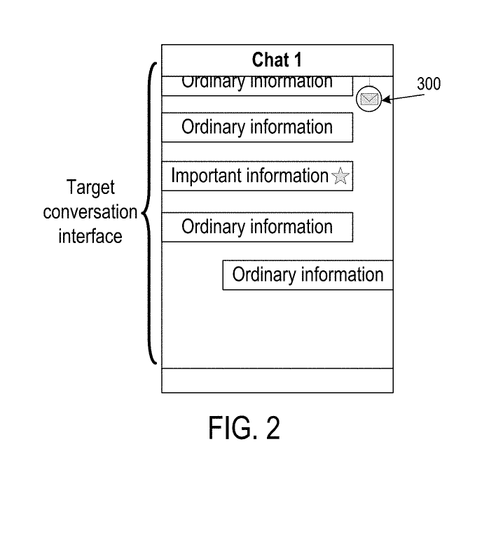

When the method determines that there is an unread message in the messages sent to the user, a message prompt indicator may be displayed on the group conversation interface to prompt the user that there is a message that has not been viewed. The message prompt indicator may be a virtual button or may comprise a set of identifiers presented differently. For example, FIG. 2 shows a schematic diagram of presentation with a message prompt indicator (300) on a group conversation interface. An envelope icon (300) in FIG. 2 may be the message prompt indicator. In addition to the indicator shape shown in FIG. 2, the message prompt indicator may use other types or shapes of indicator shapes as well.

S103: Expand a message viewing area on a partial area of the group conversation interface if an expansion operation on the message prompt indicator is received, the message viewing area used to display the unread message.

By displaying the message prompt indicator on the group conversation interface, the user who uses the smart terminal and logs into the instant messaging tool can discover that there is currently an unread message. Therefore, if the user intends to view the unread message, the user may operate the message prompt indicator to view the unread message on the group conversation interface. This operation may be pre-set to enable the smart terminal or the instant messaging tool to recognize that this operation is an operation by the user for expanding the message viewing area. Types of expansion operations may vary according to specific application scenarios. For example, the expansion operation may comprise multiple successive touches or taps on the message prompt indicator or may comprise a drag operation for the message prompt indicator (such as dragging the message prompt indicator to a position after a long press on the message prompt indicator). In another embodiment, the expansion operation may be a sliding operation for message prompt indicator, such as sliding downward or sliding leftward or rightward.

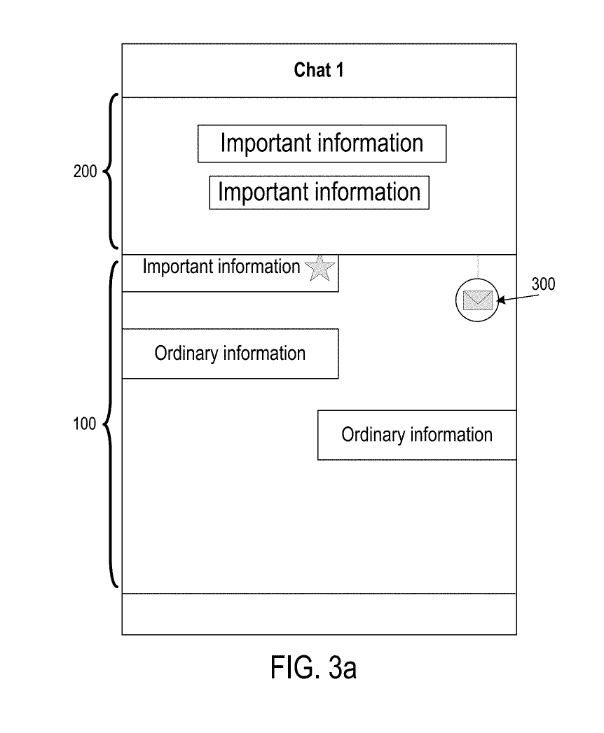

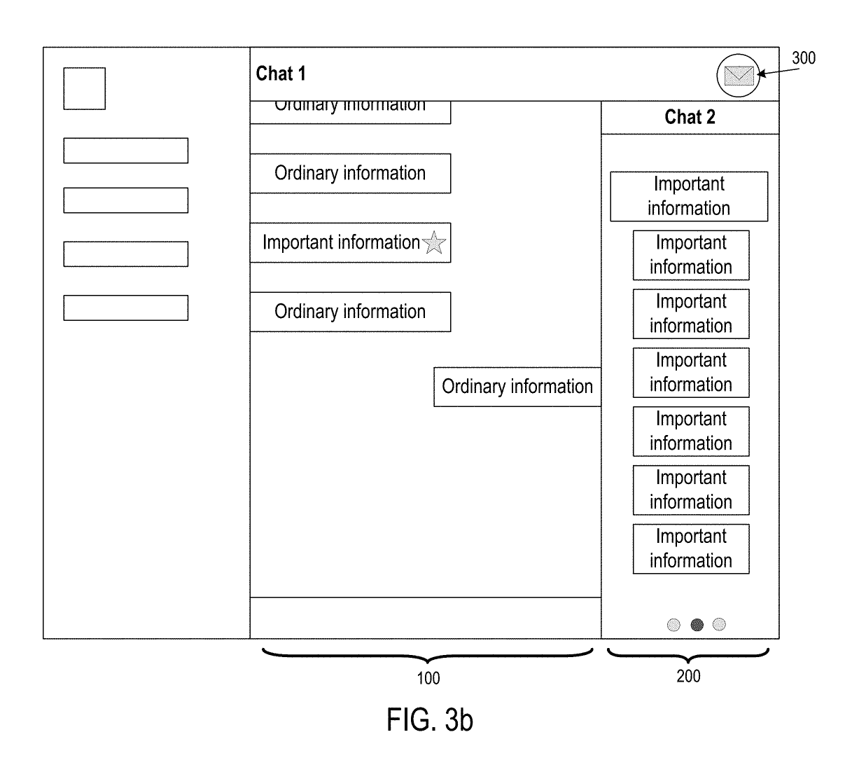

When the expansion operation for the message prompt indicator is acquired, a partial area is defined from the group conversation interface as an area for expanding the message viewing area. Accordingly, the group conversation interface is correspondingly adjusted and reduced to a part where the message viewing area is not displayed for presentation. The partial area on the group conversation interface for expanding the message viewing area may be pre-set or determined in real time according to the expansion operation, or it can be determined according to the position of the message prompt indicator. When the message viewing area is expanded, actual presentation space of the group conversation interface will be correspondingly reduced and adjusted. The message viewing area and the group conversation interface will share an area occupied by the original group conversation interface (that is, the group conversation interface when the message viewing area has not been expanded). For example, a positional relationship may be the one between the message viewing area (200) and the group conversation interface (100) as illustrated in FIG. 3A. After the message viewing area (200) is expanded, a message that is related to the user but has not been viewed by the user will be displayed in the message viewing area (200); and messages exchanged between the user, and other users will continue to be displayed on the group conversation interface (100). In this way, the user can view the unread message without missing real-time incoming messages on the group conversation interface (100); further, the user does not need to switch conversation interfaces, thereby enabling better viewing experience.

It should be noted that because the message viewing area (200) and the group conversation area (100) are displayed together on the original group conversation interface after the message viewing area is expanded, the size of the partial area needs to be specified to some extent. If the partial area is excessively large, the group conversation interface (100) after the expanding may be too small as to affect the presentation of group messages, making it difficult for the user to clearly view the content therein. On the contrary, if the partial area is excessively small, the message viewing area may be too small as to affect the presentation of the messages therein, making it difficult for the user to clearly read the unread message. Therefore, the size of the message viewing area is usually set in advance so that the presentation in the message viewing area (200) and the group conversation interface (100) can be ensured after the message viewing area (200) is expanded at various positions. For example, it may be specified that the partial area should not be greater than half of the area of the original group conversation interface.

It can be seen that when a group conversation interface is active if an unread message exists among the received messages sent to a user, a message prompt indicator (300) may be displayed on the group conversation interface. When intending to view the unread message, the user may perform an expansion operation on the message prompt indicator (300). In response, the instant messaging tool will directly expand a message viewing area (200) within a partial area of the group conversation interface and display the unread message unread to the user in the message viewing area (200). Because the message viewing area (200) and the group conversation interface (100) are displayed at the same time, the user does not have to leave the current group conversation interface (100) when viewing the message in the message viewing area (200). That is, the user may view conversational messages on the group conversation interface (100). This message viewing manner simplifies the operations, and the user does not need to switch conversation interfaces. Furthermore, messages being currently exchanged on the group conversation interface (100) will not be missed, thereby improving the user experience.

Especially when the messages sent to the user are important messages related to the user, the important messages related to the user can be displayed together on the message viewing area (200). The important messages can be clearly and independently displayed to the user. This mechanism greatly reduces the probability of the user missing important messages in a large number of messages or not being able to find important messages, which is common in current applications. Viewing time is greatly reduced, and the user experience is improved. Moreover, the user does not need to switch conversation interfaces when viewing the important information, so that the user will not miss messages currently being exchanged on the group conversation interface (100), thereby further improving the user experience. Furthermore, because the message viewing area (200) presents important unread messages, statistics on the important unread messages can be collected to some extent, allowing the user to learn about the number of important unread messages, and improving the user experience.

Possible positions for expanding the message viewing area will further be described below. In one embodiment, the position on the group conversation interface for expanding the message viewing area is not limited. For example, the position may be in the upper half of the group conversation interface (100), or may at the border of the group conversation interface (100), or may be in a pre-set area in the middle of the group conversation interface (100). For the clarity of description, the disclosed embodiments provide several positions that are commonly used as possible partial area. The partial area comprises any one of the following three areas.

(1) a partial area extending downward from an area displaying a conversation title on the group conversation interface.

(2) a partial area extending rightward from a left border on the group conversation interface.

(3) a partial area extending leftward from a right border on the group conversation interface.

FIG. 3A illustrates the first possibility. After expanding, the upper half of the entire window presents the message viewing area (200) and the lower half continues displaying the group conversation interface (100). The presentation manners of the second possibility and the third possibility are similar, both of which place the message viewing area at borders of the group conversation interface. The two possibilities may be mainly used for a wide-screen smart terminal or a horizontally used common smart terminal. When the width of a presentation window of a smart terminal is wider, expanding the message viewing area at borders can allocate presentation space more reasonably, so that after the message viewing area is expanded, both the message viewing area and the group conversation area can provide better presentation effects. For example, FIG. 3B shows a possible presentation case for the third possibility. After expanding, the message viewing area (200) is displayed at the right border of the group conversation interface (100).

The position of the partial area for expanding the message viewing area may be determined according to the position of the message prompt indicator (300). For example, the message prompt indicator (300) is located above the group conversation interface, such as the position shown in FIG. 2. In this case, the partial area for expanding the message viewing area (200) may be the upper half of the group conversation interface. For example, the message prompt indicator (300) is located at a border of the group conversation interface. In this case, the partial area for expanding the message viewing area (200) may be a border part of the group conversation interface corresponding to the position of the message prompt indicator.

The position of the partial area for expanding the message viewing area (200) may also be pre-set. For example, if the partial area is pre-set in the upper half of the group conversation interface, regardless of the position of the message prompt indicator (300). When an expansion operation is performed on the message prompt indicator (300), the message viewing area (200) will be expanded in the upper half of the group conversation interface.

The position of the partial area for expanding the message viewing area (200) may also be dynamically determined according to an expansion operation of the user on the message prompt indicator (300). When the expansion operation includes a drag operation, if a drag operation for the message prompt indicator (300) is acquired, the message prompt indicator (300) may be moved in response to the drag operation, which is equivalent to the effect of following-the-movement presentation.

When determining that the drag operation is completed, expanding the message viewing area (200) on the partial area of the group conversation interface according to a positional relationship between a position where the drag operation is completed and the group conversation interface.

The message prompt indicator (300) located at the position shown in FIG. 2 is now used as an example. When the position at which the drag operation is completed is in the upper half of the group conversation interface, the partial area may be determined to be the upper half of the group conversation interface, and the message viewing area (200) may be expanded in the upper half of the group conversation interface. When the position at which the drag operation is completed is in the left part of the group conversation interface, the partial area may be determined to be the left part of the group conversation interface, and the message viewing area (200) may be expanded in the left part of the group conversation interface.

To accurately expand the message viewing area (200), it may be determined whether the position at which the drag operation is completed meets an expanding condition before the message viewing area is expanded. If so, expanding the message viewing area on the partial area of the group conversation interface according to a positional relationship between a position where the drag operation is completed and the group conversation interface.

Specifying the expanding condition such as whether the position at which the drag operation is completed is within an appropriate area effectively avoids the following situations when it is determined that the position at which the drag operation is completed satisfies the expanding condition: the situation when the position at which the drag operation is completed locates within a less accurate range (for example, between the left part and the right part); and the situation when the position at which the drag operation is completed falls outside the group conversation interface. Such a mechanism avoids the occurrence of situations in which the position at which the message viewing area (200) is expanded is unknown or at a wrong position, increasing the accuracy of expanding the message viewing area, and therefore improving the user experience.

After it is clear that the message viewing area is used to present a message related to the user and has not been viewed by the user, how to present the message in the message viewing area and the various types of processing that the message viewing area can provide for the message will be described as follows.

In the message viewing area (200), at least one message may be simultaneously displayed. The specific number of simultaneously displayed messages may be related to the size of the message viewing area (200) and may also be related to the message displaying format. When displaying messages, some of the messages may be highlighted, and a highlighting manner is not limited. For example, the message may be in bold, enlarged, or shown in a different font color. The highlighting manner may be as shown in FIG. 3A or FIG. 3B, in which the message viewing area (200) has important messages highlighted in an enlarged manner.

For example, by highlighting some messages or some message in the message viewing area (200), the presentation effect can be effectively improved. For example, a pre-set area or position, like the middle or a first row of the message viewing area, may be set in the message viewing area (200), and the information at this position may be highlighted. Alternatively, when a message in the message viewing area (200) is selected by the user, the selected message may be highlighted. That is, the user may select a message in the message viewing area (200) using touch control or the like. When the user selects a message, it may reflect that the user wants to read this message. Therefore, the message is highlighted to make it convenient to read for the user, thereby achieving a better presentation effect.

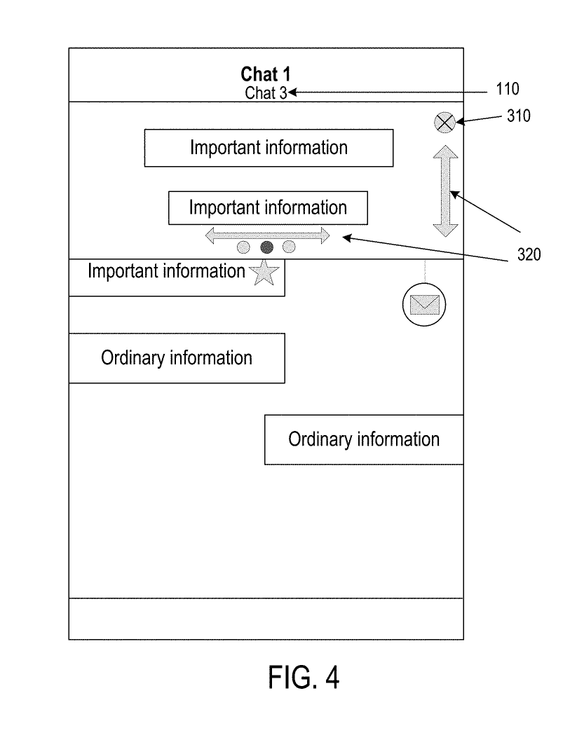

There may exist a message that does not belong to the conversation corresponding to the group conversation interface (100) among the unread messages. To present the unread messages to the user, when the selected message is not a message in the conversation corresponding to the group conversation interface (100), a conversation title of the conversation to which the selected message belongs may be displayed. The position for displaying the conversation title of the conversation to which the selected message belongs is not limited. For example, the conversation title may be displayed in the vicinity of the selected message or may also be displayed in an area dedicated to displaying a conversation title. For example, the conversation title of the conversation to which the selected message belongs is displayed in the area on the group conversation interface for displaying a conversation title. A specific example may be as shown in FIG. 4, where “Chat 3” (110) is the conversation title of the conversation to which the selected message belongs. “Chat 1” may be a conversation title of the conversation corresponding to the group conversation interface. By displaying the conversation title corresponding to the selected message, the user is able to understand content carried by the selected message more clearly and directly.

After displaying the unread message to the user, the displayed message may already be viewed by the user. To improve the display quality, in one embodiment, a delete button (310) is provided in the message viewing area, and the delete button (310) may be a set virtual button.

The user can delete a read message by touching the delete button, thereby reducing the number of messages remaining in the message viewing area and avoiding repeated reading of the same message or missing a message due to excessive messages. Therefore, optionally, when a triggering operation for the delete button is acquired, the selected message in the message view area is set as read and the message is deleted. Because all messages displayed in the message viewing area are unread messages, the message viewing area may no longer display the message set as read. After the message is deleted, the number of displayed messages in the message viewing area can be reduced, thereby improving the display efficiency.

In addition to using the delete button to accurately delete a selected message, a clear button for clearing messages in the message viewing area may further be provided in the message viewing area. The clear button may be a set virtual button. For example, an icon (310) in FIG. 4 may represent the clear button. When a triggering operation on the clear button (310) is acquired, all messages in the message view area are set as read and the messages are cleared. In this way, the deletion efficiency is increased. The user does not need to delete read messages one by one. This is particularly efficient for the user when a large number of messages exist, that is, the messages may be deleted more efficiently with the clear button, thereby improving the user experience.

Due to the limited space of the message viewing area and the limited number of messages that can be displayed at the same time, it may not be possible to display all unread messages at the same time when a large number of unread messages exist. In this case, a function of scrolling through messages is provided in the message viewing area. Displayed messages may be changed by a sliding operation of the user in the message viewing area. Therefore, after the message viewing area is expanded in the partial area of the group conversation interface, the method further includes, if all unread messages cannot be displayed within the message viewing area and when a sliding operation on the message viewing area is acquired, adjusting displayed messages according to the direction of the sliding operation.

The sliding operation may be performed at any position in the message viewing area. However, to improve the accuracy of feedback on the sliding operation, a scroll bar (320) in FIG. 4, may be provided in the message viewing area. The user may perform a sliding operation at the position shown by scroll bar (320).

The sliding operation may include a sliding operation in a vertical direction or a sliding operation in a horizontal direction. Different sliding operations may be used according to the arrangement of messages in the message viewing area. For example, if the messages are arranged in columns, messages arranged above or below the currently displayed message may be displayed by using a sliding operation in a vertical direction. If the messages are arranged in pages, a page may be turned by using a sliding operation in a horizontal direction.

Because the message viewing area mainly displays unread messages, if the user needs to view and read one of the messages in detail, the user may need to view contextual messages of this message. Therefore, the message viewing area also provides a function of viewing the context. A contextual message may be viewed by using a viewing operation; and the viewing operation may be a pre-set operation manner, such as a double click or a long press on the message.

If a viewing operation on a message within the message viewing area is acquired, a conversation to which the message selected by the viewing operation belongs is determined.

If the conversation to which the message selected with the viewing operation belongs is the conversation corresponding to the group conversation interface, a context message for the message selected with the viewing operation is displayed on the group conversation interface.

If the conversation to which the message selected with the viewing operation belongs is another conversation, it is switched to an interface for other conversations, and a context message for the message selected with the viewing operation is displayed on the interface for other conversations.

For example, if a message requiring a context message belongs to the conversation corresponding to the group conversation interface, the user does not need to leave the current group conversation interface; instead, the user will be taken directly to the message and the message selected with the viewing operation (and its context message) will be displayed. If the message selected by the viewing operation belongs to another conversation, conversation interfaces may be switched, so as to display the message and its context message. When switching to another conversation interface, the message viewing area may be closed, or may be retained and continued with its display, which is not limited herein.

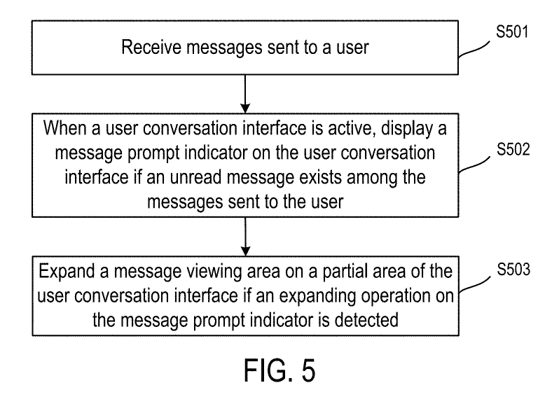

FIG. 5 is a flow diagram illustrating a message displaying method according to some embodiments of the disclosure. In one embodiment, the illustrated method is performed by an instant messaging tool configured on a smart terminal.

S501: Receive messages sent to a user, wherein the user is a user logging into the instant messaging tool on the smart terminal.

S502: When a user conversation interface is active, display a message prompt indicator on the user conversation interface if an unread message exists among the messages sent to the user.

The conversation interface is an interface for conversations between the user and other users, such as a user A. In this case, the group conversation interface may be a conversation interface, or a chat window, for the conversation between the user and the user A. The message prompt indicator is used to prompt that an unread message exists.

S503: Expand a message viewing area on a partial area of the user conversation interface if an expansion operation on the message prompt indicator is detected, the message viewing area used to display the unread message.

Optionally, the partial area comprises any one of the following three areas:

(1) a partial area extending downward from an area displaying a conversation title on the user conversation interface;

(2) a partial area extending rightward from a left border on the user conversation interface; or

(3) a partial area extending leftward from a right border on the user conversation interface.

Optionally, the expansion operation comprises a drag operation, and the expanding a message viewing area on a partial area of the user conversation interface if an expansion operation on the message prompt indicator is acquired further comprises moving the message prompt indicator in response to the drag operation if the drag operation on the message prompt indicator is acquired; and when determining that the drag operation is completed, expanding the message viewing area on the partial area of the user conversation interface according to a positional relationship between a position where the drag operation is completed and the user conversation interface.

Optionally, prior to expanding the message viewing area on the partial area of the user conversation interface according to a positional relationship between a position where the drag operation is completed and the user conversation interface, the method further comprises: determining whether the position where the drag operation is completed meets an expanding condition; and if so, expanding the message viewing area on the partial area of the user conversation interface according to the positional relationship between the position where the drag operation is completed and the user conversation interface.

Optionally, a message at a pre-set position is highlighted within the message viewing area.

Optionally, when a message in the message viewing area is selected by the user, the selected message is highlighted in the message viewing area.

Optionally, a conversation title of a conversation to which the selected message belongs is displayed if the selected message is not a message in the conversation corresponding to the user conversation interface.

Optionally, the displaying a conversation title of a conversation to which the selected message belongs comprises displaying the conversation title of the conversation to which the selected message belongs in an area for displaying a conversation title on the user conversation interface.

Optionally, a delete button is provided within the message viewing area, and the method further comprises setting the selected message in the message view area as read and deleting the message when acquiring a triggering operation on the delete button.

Optionally, a clear button is provided within the message viewing area, and the method further comprises when a triggering operation on the clear button is acquired, all messages in the message view area are set as read and the messages are cleared.

Optionally, after the expanding the message viewing area on the partial area of the user conversation interface, the method further comprises: if all unread messages cannot be displayed within the message viewing area and when a sliding operation on the message viewing area is acquired, adjusting displayed messages according to the direction of the sliding operation.

Optionally, the sliding operation comprises a sliding operation in a vertical direction or a horizontal direction.

Optionally, after the expanding the message viewing area on the partial area of the user conversation interface, the method further comprises: determining a conversation to which the message selected by the viewing operation belongs if a viewing operation on a message within the message viewing area is acquired; displaying, on the user conversation interface, a context message for the message selected with the viewing operation if the conversation to which the message selected with the viewing operation belongs is the conversation corresponding to the user conversation interface; and if the conversation to which the message selected with the viewing operation belongs is another conversation, it is switched to an interface for other conversations, and a context message for the message selected with the viewing operation is displayed on the interface for other conversations.

Optionally, after the receiving of messages sent to a user, the method further comprises: determining whether the messages sent to the user meet a pre-set condition; if so, determining that the messages sent to the user are important messages; and performing the step of displaying a message prompt indicator on the group conversation interface if an unread message exists among the messages sent to the user and when a group conversation interface is active.

Optionally, the pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship, and the messages satisfy a pre-set rule.

For descriptions of the foregoing steps and features, reference may be made to the related descriptions of the steps and features corresponding to the embodiments discussed in the description of FIGS. 1, 2, 3A, 3B, and 4, and details are not described herein again.

As illustrated, when a user conversation interface is active, if an unread message exists among the received messages sent to a user, a message prompt indicator may be displayed on the user conversation interface. When intending to view the unread message, the user may perform an expansion operation on the message prompt indicator, and the instant messaging tool will directly expand a message viewing area within a partial area of the user conversation interface and display the unread message unread to the user in the message viewing area. Because the message viewing area and the user conversation interface are displayed at the same time, the user does not have to leave the current user conversation interface when viewing the message in the message viewing area. That is, the user may view conversational messages on the user conversation interface. This message viewing manner simplifies the operations, and the user does not need to switch conversation interfaces. Furthermore, messages being currently exchanged on the user conversation interface will not be missed, thereby improving the user experience.

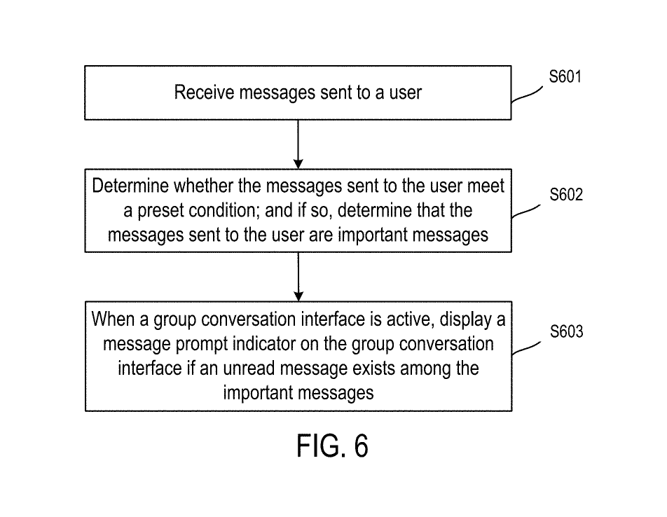

The embodiments illustrated in FIG. 6 further provide message prompting methods. With these embodiments, important messages among messages may be determined; and a user may be reminded of the determined important messages. The important messages herein are messages that the user needs to view or messages that include content that needs the user to read. Additionally, important messages herein are more highly expected to be viewed by the user, and the content included therein is also more important. For example, in a group, because everyone can send a message, a large number of messages usually exist. If the messages include an important message related to a user A, the message is quite likely to be included within the large number of messages. If the user A intends to view the message, the user A may need to manually browse through the large number of messages of the group in order to find the important message. This will not be a pleasant experience for the user, and sometimes a user in this case even cannot find the important message, resulting in unnecessary loss of time and information. Therefore, important messages need to be identified and a user needs to be prompted in a timely manner.

FIG. 6 is a flow diagram illustrating a message prompting method according to some embodiments of the disclosure.

S601: Receive messages sent to a user, wherein the user is a user logging into the instant messaging tool on the smart terminal.

It should be noted that the messages sent to the user may be group messages sent to a group to which a group conversation interface mentioned in S603 belongs, or may be group messages or single-person messages sent by other users or groups to the user.

S602: Determine whether the messages sent to the user meet a pre-set condition. If so, determine that the messages sent to the user are important messages.

To prompt the user more accurately for important messages related to the user, it may be needed to identify which messages are important ones from the messages sent to the user. If it is determined that the messages sent to the user are important ones, S603 may be performed in this case. If it is determined that the messages sent to the user are not important ones, the user may not be prompted in this case. An example of prompting is to display a message prompt identifier on the group conversation interface.

S603: When a group conversation interface is active, display a message prompt indicator on the group conversation interface if an important unread message exists among the important messages, the group conversation interface comprising an interface for conversations between the user and a plurality of other users, and the message prompt indicator used to prompt the user for an unread message.

It can be seen that for received messages that are sent to a user, if it is determined that some messages therefrom meet a pre-set condition, the messages can be determined to be important messages sent to the user. When a group conversation interface is active, if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

The illustrated embodiments also provide a plurality of techniques for determining important messages. Optionally, the pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship.

When it is determined that the messages are important, the messages need to meet the pre-set condition, and the pre-set condition may be determined according to a pre-set rule. The pre-set rule may be defined by a developer according to the requirement of the user in advance; or the pre-set rule may be concluded via machine learning or artificial intelligence self-learning; and machine learning and artificial intelligence recommendation may be optimized based on feedback from the user. The pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship.

For example, the pre-set condition may be that a sender of a message meets a predetermined relationship with the user. For example, the predetermined relationship may be that the sender is the manager of the user at work. When the user is a user C, if the manager of the user C sends a message in a work group, since the sender is the manager who satisfies the predetermined relationship with the user C, the message can be determined to be an important message related to the user C in the work group.

The pre-set condition is further set as including a special character or having a special format. When a character included in the message or the format of a message sent by the user a to the user B satisfies the pre-set condition, the message may be determined to be an important message related to the user B.

The pre-set condition may further include that the content of a message includes specific linguistic data, and the specific linguistic data may be words or numbers. For example, the specific linguistic data may be a keyword or a key figure that the user pays attention to. When a message sent to the user includes the specific linguistic data, the message will be determined to be an important message belonging to the user. The specific linguistic data may be related to a hobby of the user or reflect the hobby of the user. The specific linguistic data may be set by the user or may be generated by a machine according to network behaviors of the user.

For example, there might be 100 users in a group, among which 20 users set up a hobby-related label for themselves as “soccer.” If a user in this group sends a message with the content “Kicking balls this afternoon?”, by learning associations with the machine, a system can determine that “kicking balls” and “soccer” are relevant. That is, “kicking balls” may be considered as specific linguistic data related to the 20 users with the label “soccer.” The message will be determined to be an important message to the 20 users and a prompt will be sent when anyone in the 20 users has not read this message.

For another example, if a user in a group follows news like “fine cuisine,” the system may consider that the user is fond of delicious food, and may set linguistic data related to fine cuisine as specific linguistic data related to the user. When the content of a message sent by a user to this specific user includes fine cuisine-related content such as “the sliced fish in hot chili oil at the restaurant xx is very delicious,” the phrase “sliced fish in hot chili oil” may be identified as specific linguistic data related to the user and the message may be determined to be an important message to the user. If the user has not read this message, the user may be prompted.

The pre-set condition may further include that the content of a message includes an identifier of the user. The identifier of the user may be content that can be used to identify the user, such as a user name, a real name, and a job number of the user. When a message sent to the user includes the identifier of the user, the message will be determined to be an important message to the user.

The pre-set condition may further include that the content of a message is related to the content of a historical message sent by the user. Whether a message sent to the user is related to a message previously sent by the user may be identified by means of machine learning or automatic AI determination. For example, the message being a reply to the message previously sent by the user or the message referring to the content of the message previously sent by the user may be determined to be related to the content of a historical message sent by the user. To improve computational efficiency, a historical message may be defined by using a time range. For example, messages sent by the user in a recent period of time may be defined as historical messages sent by the user. Alternatively, historical messages may be defined by the number of sent messages. For example, N messages recently sent by the user are defined as historical messages sent by the user.

The pre-set condition may also include a label of the user, and the label of the user may be a label marked by a system for the message and used to identify the message as an important message for the user. When it is identified that a message sent to the user includes such a label, the message may be determined to be an important message belonging to the user.

In this embodiment, in addition to prompting the user for important messages, a convenient manner of viewing messages can be provided for the user by expanding the message viewing area. Optionally, the method further includes expanding a message viewing area on a partial area of the group conversation interface if an expansion operation on the message prompt indicator is acquired, wherein the message viewing area is used to display the unread important message.

It can be seen that when a user intends to view the important unread message, the user may perform an expansion operation on the message prompt indicator, and the instant messaging tool will directly expand a message viewing area within a partial area of the group conversation interface and display the important unread message unread to the user in the message viewing area. Because the message viewing area and the group conversation interface are displayed at the same time, the user does not have to leave the current group conversation interface when viewing the important message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

Optionally, the partial area comprises any one of the following three areas:

(1) a partial area extending downward from an area displaying a conversation title on the group conversation interface;

(2) a partial area extending rightward from a left border on the group conversation interface; or

(3) a partial area extending leftward from a right border on the group conversation interface.

Optionally, the expansion operation comprises a drag operation, and the expanding a message viewing area on a partial area of the group conversation interface if an expansion operation on the message prompt indicator is acquired further comprises: moving the message prompt indicator in response to the drag operation if the drag operation on the message prompt indicator is acquired; and when determining that the drag operation is completed, expanding the message viewing area on the partial area of the group conversation interface according to a positional relationship between a position where the drag operation is completed and the group conversation interface.

Optionally, prior to expanding the message viewing area on the partial area of the group conversation interface according to a positional relationship between a position where the drag operation is completed and the group conversation interface, the method further comprises: determining whether the position where the drag operation is completed meets an expanding condition; and if so, expanding the message viewing area on the partial area of the group conversation interface according to the positional relationship between the position where the drag operation is completed and the group conversation interface.

Optionally, a message at a pre-set position is highlighted within the message viewing area.

Optionally, when a message in the message viewing area is selected by the user, the selected message is highlighted in the message viewing area.

Optionally, a conversation title of a conversation to which the selected message belongs is displayed if the selected message is not a message in the conversation corresponding to the group conversation interface.

Optionally, the displaying a conversation title of a conversation to which the selected message belongs comprises displaying the conversation title of the conversation to which the selected message belongs in an area for displaying a conversation title on the group conversation interface.

Optionally, a delete button is provided within the message viewing area, and the method further comprises setting the selected message in the message view area as read and deleting the message when acquiring a triggering operation on the delete button.

Optionally, a clear button is provided within the message viewing area, and the method further comprises, when a triggering operation on the clear button is acquired, setting all messages in the message view area as read and the clearing messages are cleared.

Optionally, after the expanding the message viewing area on the partial area of the group conversation interface, the method further comprises, if all unread messages cannot be displayed within the message viewing area and when a sliding operation on the message viewing area is acquired, adjusting displayed messages according to the direction of the sliding operation.

Optionally, the sliding operation comprises a sliding operation in a vertical direction or a horizontal direction.

Optionally, after the expanding the message viewing area on the partial area of the group conversation interface, the method further comprises: determining a conversation to which the message selected by the viewing operation belongs if a viewing operation on a message within the message viewing area is acquired; displaying, on the group conversation interface, a context message for the message selected with the viewing operation if the conversation to which the message selected with the viewing operation belongs is the conversation corresponding to the group conversation interface; and switching to an interface for other conversations, and displaying, on the interface for other conversations, a context message for the message selected with the viewing operation if the conversation to which the message selected with the viewing operation belongs is another conversation.

It should be noted that for other unspecified features and steps in this embodiment, reference may be made to the related descriptions for the related features and steps in the embodiments discussed in the description of FIGS. 1, 2, 3A, 3B, and 4, and details are not described herein again.

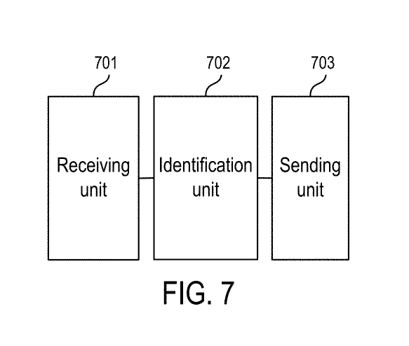

FIG. 7 is a block diagram illustrating a server according to some embodiments of the disclosure. This embodiment is an embodiment at a server corresponding to the embodiments discussed in the description of FIG. 6. In the illustrated embodiment, the server includes a receiving unit (701), an identification unit (702), and a sending unit (703).

The receiving unit (701) is configured to receive messages sent to a user, wherein the user is a user logging into an instant messaging tool on a smart terminal.

The identification unit (702) is configured to determine whether the messages sent to the user meet a pre-set condition. If so, the identification unit (702) determines that the messages sent to the user are important messages.

The sending unit (703) is configured to forward the important messages to the instant messaging tool.

Optionally, the pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship.

It can be seen that for received messages that are sent to a user, if it is determined that some messages therefrom meet a pre-set condition, the messages can be determined to be important messages sent to the user. When a group conversation interface is active, if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

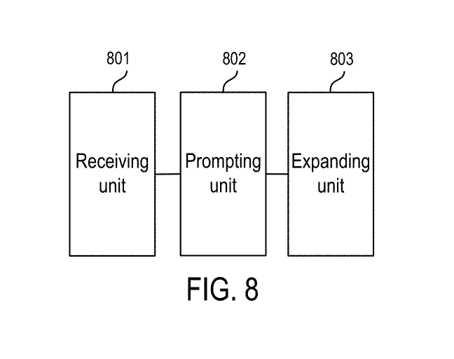

FIG. 8 is a block diagram illustrating a message displaying apparatus according to some embodiments of the disclosure. This embodiment is a device embodiment corresponding to the embodiments discussed in the description of FIGS. 1, 2, 3A, 3B, and 4. In the illustrated embodiment, the apparatus may be applicable to an instant messaging tool and is configured on a smart terminal. The apparatus includes a receiving unit (801), a prompting unit (802), and an expanding unit (803).

The receiving unit (801) is configured to receive messages sent to a user, wherein the user is a user logging into the instant messaging tool on the smart terminal.

The prompting unit (802) is configured to, when a group conversation interface is active, display a message prompt indicator on the group conversation interface if an unread message exists among the messages sent to the user, wherein the group conversation interface is an interface for conversations between the user and a plurality of other users, and the message prompt indicator is used to prompt the user for an unread message.

The expanding unit 803 is configured to expand a message viewing area on a partial area of the group conversation interface if an expansion operation on the message prompt indicator is acquired, wherein the message viewing area is used to display the unread message.

Optionally, the partial area comprises any one of the following three areas:

(1) a partial area extending downward from an area displaying a conversation title on the group conversation interface;

(2) a partial area extending rightward from a left border on the group conversation interface; or

(3) a partial area extending leftward from a right border on the group conversation interface.

Optionally, the expanding unit is further configured to do the following: if a drag operation on the message prompt indicator is acquired, moving the message prompt indicator in response to the drag operation; and when determining that the drag operation is completed, expanding the message viewing area on the partial area of the group conversation interface according to a positional relationship between a position where the drag operation is completed and the group conversation interface.

Optionally, the apparatus further comprises a determining unit, wherein the determining unit is configured to determine whether the position at which the drag operation is completed meets an expanding condition. If so, expanding the message viewing area on the partial area of the group conversation interface according to a positional relationship between a position where the drag operation is completed and the group conversation interface.

Optionally, the apparatus further comprises a display unit, wherein the display unit is configured to highlight a message at a pre-set position within the message viewing area.

Optionally, the display unit is further configured to, when a message in the message viewing area is selected by the user, the selected message is highlighted in the message viewing area.

Optionally, the display unit is further configured to display a conversation title of a conversation to which the selected message belongs if the selected message is not a message in the conversation corresponding to the group conversation interface.

Optionally, the presentation unit is further configured to display the conversation title of the conversation to which the selected message belongs in an area for displaying a conversation title on the group conversation interface.

Optionally, a delete button is provided within the message viewing area, and the apparatus further comprises a deletion unit, wherein the deletion unit is configured to set the selected message in the message view area as read and delete the message when acquiring a triggering operation on the delete button.

Optionally, a clear button is provided within the message viewing area, and the apparatus further comprises a clearing unit, wherein the clearing unit is configured to set all messages in the message view area as read and clear the messages when acquiring a triggering operation on the clear button.

Optionally, the apparatus further comprises a sliding unit, wherein the sliding unit is configured to do the following: if all unread messages cannot be displayed within the message viewing area, and when a sliding operation on the message viewing area is acquired, adjusting displayed messages according to the direction of the sliding operation.

Optionally, the sliding operation comprises a sliding operation in a vertical direction or a horizontal direction.

Optionally, the apparatus further comprises a context unit, wherein the context unit is configured to do the following: if a viewing operation on a message within the message viewing area is acquired, determine a conversation to which the message selected with the viewing operation belongs; if the conversation to which the message selected with the viewing operation belongs is the conversation corresponding to the group conversation interface, display a context message for the message selected with the viewing operation on the group conversation interface; and if the conversation to which the message selected with the viewing operation belongs is another conversation, switch to an interface for other conversations, and display, on the interface for other conversations, a context message for the message selected with the viewing operation.

Optionally, the determining unit is further configured to determine whether the messages sent to the user meet a pre-set condition. If so, determine that the messages sent to the user are important messages; and perform the step of displaying a message prompt indicator on the group conversation interface if an unread message exists among the messages sent to the user, and when a group conversation interface is active.

Optionally, the pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship, and the messages satisfy a pre-set rule.

It should be noted that for the features in this embodiment, reference may be made to the related descriptions for the related features in the embodiments discussed in the description of FIGS. 1, 2, 3A, 3B, and 4, and details are not described herein again.

It can be seen that when a group conversation interface is active, if an unread message exists among the received messages sent to a user, a message prompt indicator may be displayed on the group conversation interface. When intending to view the unread message, the user may perform an expansion operation on the message prompt indicator, and the instant messaging tool will directly expand a message viewing area within a partial area of the group conversation interface and display the unread message unread to the user in the message viewing area. Because the message viewing area and the group conversation interface are displayed at the same time, the user does not have to leave the current group conversation interface when viewing the message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

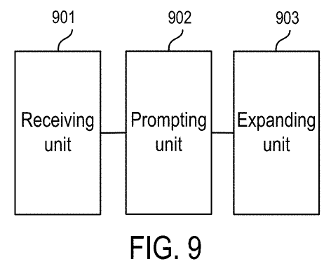

FIG. 9 is a block diagram illustrating a message displaying apparatus according to some embodiments of the disclosure. This embodiment is an apparatus embodiment corresponding to the embodiments discussed in the description of FIG. 5. The illustrated embodiments may be applicable to an instant messaging tool and is configured on a smart terminal. The apparatus includes a receiving unit (901), a prompting unit (902), and an expanding unit (903).

The receiving unit (901) is configured to receive messages sent to a user, wherein the user is a user logging into the instant messaging tool on the smart terminal.

The prompting unit (902) is configured to do the following: when a user conversation interface is active, displaying a message prompt indicator on the user conversation interface if an unread message exists among the messages sent to the user, wherein the user conversation interface is an interface for conversations between the user and other users, and the message prompt indicator is used to prompt the user for an unread message.

The expanding unit (903) is configured to expand a message viewing area on a partial area of the user conversation interface if an expansion operation on the message prompt indicator is acquired, wherein the message viewing area is used to display the unread message.

Optionally, the partial area comprises any one of the following three areas:

(1) a partial area extending downward from an area displaying a conversation title on the user conversation interface;

(2) a partial area extending rightward from a left border on the user conversation interface; or

(3) a partial area extending leftward from a right border on the user conversation interface.

Optionally, the expanding unit is further configured to do the following: if a drag operation on the message prompt indicator is acquired, moving the message prompt indicator in response to the drag operation; and when determining that the drag operation is completed, expanding the message viewing area on the partial area of the user conversation interface according to a positional relationship between a position where the drag operation is completed and the user conversation interface.

Optionally, the apparatus further comprises a determining unit, wherein the determining unit is configured to determine whether the position at which the drag operation is completed meets an expanding condition. If so, expanding the message viewing area on the partial area of the user conversation interface according to a positional relationship between a position where the drag operation is completed and the user Conversation interface.

Optionally, the apparatus further comprises a display unit, wherein the display unit is configured to highlight a message at a pre-set position within the message viewing area.

Optionally, the display unit is further configured to do the following: when a message in the message viewing area is selected by the user, the selected message is highlighted in the message viewing area.

Optionally, the display unit is further configured to display a conversation title of a conversation to which the selected message belongs if the selected message is not a message in the conversation corresponding to the user conversation interface.

Optionally, the presentation unit is further configured to display the conversation title of the conversation to which the selected message belongs in an area for displaying a conversation title on the user conversation interface.

Optionally, a delete button is provided within the message viewing area, and the apparatus further comprises a deletion unit, wherein the deletion unit is configured to set the selected message in the message view area as read and delete the message when acquiring a triggering operation on the delete button.

Optionally, a clear button is provided within the message viewing area, and the apparatus further comprises a clearing unit, wherein the clearing unit is configured to set all messages in the message view area as read and clear the messages when acquiring a triggering operation on the clear button.

Optionally, the apparatus further comprises a sliding unit, wherein the sliding unit is configured to do the following: if all unread messages cannot be displayed within the message viewing area and when a sliding operation on the message viewing area is acquired, adjusting displayed messages according to the direction of the sliding operation.

Optionally, the sliding operation comprises a sliding operation in a vertical direction or a horizontal direction.

Optionally, the apparatus further comprises a context unit, wherein the context unit is configured to do the following: if a viewing operation on a message within the message viewing area is acquired, determine a conversation to which the message selected with the viewing operation belongs; if the conversation to which the message selected with the viewing operation belongs is the conversation corresponding to the user conversation interface, display a context message for the message selected with the viewing operation on the user conversation interface; and if the conversation to which the message selected with the viewing operation belongs is another conversation, switch to an interface for other conversations, and display, on the interface for other conversations, a context message for the message selected with the viewing operation.

Optionally, the determining unit is further configured to determine whether the messages sent to the user meet a pre-set condition. If so, determine that the messages sent to the user are important messages; and perform the step of displaying a message prompt indicator on the user conversation interface if an unread message exists among the messages sent to the user and when a user conversation interface is active.

Optionally, the pre-set condition includes a combination of any one or more of the following: the content of the messages including specific linguistic data; the content of the messages being related to content of a historical message sent by the user; the content of the messages comprising an identifier of the user, a sender of the messages and the user meeting a predetermined relationship, and the messages satisfy a pre-set rule.

It should be noted that for the features in this embodiment, reference may be made to the related descriptions for the related features in the embodiments discussed in the description of FIG. 5, and details are not described herein again.

It can be seen that when a user conversation interface is active, if an unread message exists among the received messages sent to a user, a message prompt indicator may be displayed on the user conversation interface. When intending to view the unread message, the user may perform an expansion operation on the message prompt indicator, and the instant messaging tool will directly expand a message viewing area within a partial area of the user conversation interface and display the unread message unread to the user in the message viewing area. Because the message viewing area and the user conversation interface are displayed at the same time, the user does not have to leave the current user conversation interface when viewing the message in the message viewing area. That is, the user may view conversational messages on the user conversation interface. This message viewing manner simplifies the operations, and the user does not need to switch conversation interfaces. Furthermore, messages being currently exchanged on the user conversation interface will not be missed, thereby improving the user experience.

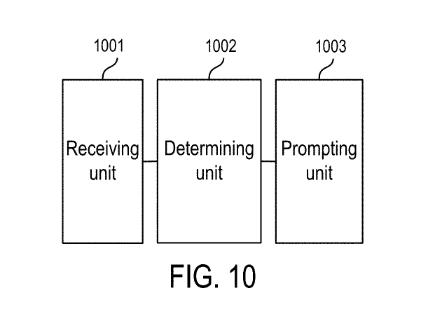

FIG. 10 is a block diagram illustrating a message displaying apparatus according to some embodiments of the disclosure. This embodiment is a device embodiment corresponding to the embodiments discussed in the description of FIG. 6. The apparatus includes a receiving unit (1001), a determining unit (1002), and a prompting unit (1003).

The receiving unit (1001) is configured to receive messages sent to a user, wherein the user is a user logging into the instant messaging tool on the smart terminal.

The determining unit (1002) is configured to determine whether the messages sent to the user meet a pre-set condition. If so, determine that the messages sent to the user are important messages.

The prompting unit (1003) is configured to do the following: when a group conversation interface is active, display a message prompt indicator on the group conversation interface if an unread message exists among the important messages, wherein the group conversation interface is an interface for conversations between the user and a plurality of other users, and the message prompt indicator is used to prompt the user for an unread message.

Optionally, the apparatus further comprises an expanding unit, wherein the expanding unit is configured to expand a message viewing area on a partial area of the group conversation interface if an expansion operation on the message prompt indicator is acquired, wherein the message viewing area is used to display the important unread message.

Optionally, the pre-set condition comprises that content of the messages includes specific linguistic data.

Optionally, the pre-set condition comprises that the content of the messages is related to content of a historical message sent by the user.

Optionally, the pre-set condition comprises that the content of the messages includes a label of the user.

Optionally, the partial area comprises any one of the following three areas:

(1) a partial area extending downward from an area displaying a conversation title on the group conversation interface;

(2) a partial area extending rightward from a left border on the group conversation interface; or

(3) a partial area extending leftward from a right border on the group conversation interface.

Optionally, the expanding unit is further configured to do the following: if a drag operation on the message prompt indicator is acquired, moving the message prompt indicator in response to the drag operation; and when determining that the drag operation is completed, expanding the message viewing area on the partial area of the group conversation interface according to a positional relationship between a position where the drag operation is completed and the group conversation interface.

Optionally, the determining unit is further configured to determine whether the position at which the drag operation is completed meets an expanding condition. If so, expanding the message viewing area on the partial area of the group conversation interface according to a positional relationship between a position where the drag operation is completed and the group conversation interface.

Optionally, the apparatus further comprises a display unit, wherein the display unit is configured to highlight a message at a pre-set position within the message viewing area.

Optionally, the display unit is further configured to do the following: when a message in the message viewing area is selected by the user, the selected message is highlighted in the message viewing area.

Optionally, the display unit is further configured to display a conversation title of a conversation to which the selected message belongs if the selected message is not a message in the conversation corresponding to the group conversation interface.

Optionally, the display unit is further configured to display the conversation title of the conversation to which the selected message belongs in an area for displaying a conversation title on the group conversation interface.

Optionally, a delete button is provided within the message viewing area, and the apparatus further comprises a deletion unit, wherein the deletion unit is configured to set the selected message in the message view area as read and delete the message when acquiring a triggering operation on the delete button.

Optionally, a clear button is provided within the message viewing area, and the apparatus further comprises a clearing unit, wherein the clearing unit is configured to set all messages in the message view area as read and clear the messages when acquiring a triggering operation on the clear button.

Optionally, the apparatus further comprises a sliding unit, wherein the sliding unit is configured to do the following: if all unread messages cannot be displayed within the message viewing area and when a sliding operation on the message viewing area is acquired, adjusting displayed messages according to the direction of the sliding operation.

Optionally, the sliding operation comprises a sliding operation in a vertical direction or a horizontal direction.

Optionally, the apparatus further comprises a context unit, wherein the context unit is configured to do the following: if a viewing operation on a message within the message viewing area is acquired, determine a conversation to which the message selected with the viewing operation belongs; if the conversation to which the message selected with the viewing operation belongs is the conversation corresponding to the group conversation interface, display a context message for the message selected with the viewing operation on the group conversation interface; and if the conversation to which the message selected with the viewing operation belongs is another conversation, switch to an interface for other conversations, and display, on the interface for other conversations, a context message for the message selected with the viewing operation.

It should be noted that for the features in this embodiment, reference may be made to the related descriptions for the related features in the embodiments discussed in the description of FIG. 6, and details are not described herein again.

It can be seen that for received messages that are sent to a user, if it is determined that some messages therefrom meet a pre-set condition, the messages can be determined to be important messages sent to the user. When a group conversation interface is active, if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

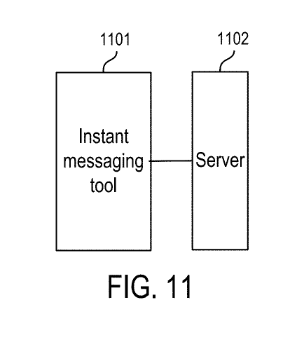

FIG. 11 is a system structural diagram of the message prompting system provided in some embodiments of the disclosure. This embodiment aims to describe a message prompting system provided by the disclosure. The system includes an instant messaging tool (1101) and a server (1102).

The instant messaging tool (1101) is configured to receive messages sent to a user, the user is a user logging into the instant messaging tool on a smart terminal, and the messages sent to the user comprising important messages; and when a group conversation interface is active, display a message prompt indicator on the group conversation interface if an important unread message exists among the important messages, wherein the group conversation interface is an interface for conversations between the user and a plurality of other users, and the message prompt indicator is used to prompt the user for an unread message.

The server (1102) is configured to receive messages sent to the user; determine whether the messages sent to the user meet a pre-set condition; if so, determine that the messages sent to the user are important messages; and forward the important messages to the instant messaging tool.

It should be noted that for the features in this embodiment, reference may be made to the related descriptions for the related features in the embodiments discussed in the description of FIGS. 1, 2, 3A, 3B, 4, and 7, and details are not described herein again.

It can be seen that when a group conversation interface is active, if an unread message exists among the received messages sent to a user, a message prompt indicator may be displayed on the group conversation interface. When intending to view the unread message, the user may perform an expansion operation on the message prompt indicator, and the instant messaging tool will directly expand a message viewing area within a partial area of the group conversation interface and display the unread message unread to the user in the message viewing area. Because the message viewing area and the group conversation interface are displayed at the same time, the user does not have to leave the current group conversation interface when viewing the message in the message viewing area. That is, the user may view conversational messages on the group conversation interface. This message viewing manner simplifies the operations, and the user does not need to switch conversation interfaces. Furthermore, messages being currently exchanged on the group conversation interface will not be missed, thereby improving the user experience.

Furthermore, for received messages that are sent to a user, if it is determined that some messages therefrom meet a pre-set condition, the messages can be determined to be important messages sent to the user. When a group conversation interface is active, if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

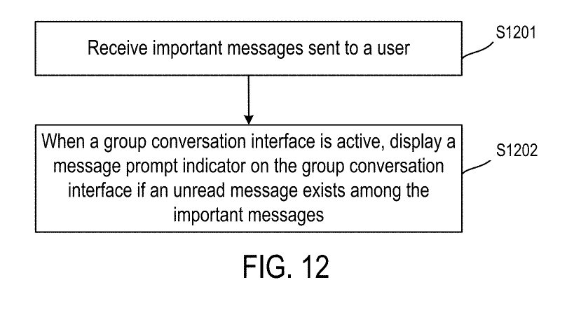

FIG. 12 is a flow diagram illustrating a message displaying method according to this embodiment of the disclosure, applicable to an instant messaging tool configured on a smart terminal, wherein the method includes:

S1201: Receive important messages sent to a user, wherein the user is a user logging into the instant messaging tool on the smart terminal, and the important messages are messages meeting a pre-set condition.

S1202: When a group conversation interface is active, display a message prompt indicator on the group conversation interface if an unread message exists among the important messages, wherein the group conversation interface is an interface for conversations between the user and a plurality of other users, and the message prompt indicator is used to prompt the user for an unread message.

Optionally, the pre-set condition comprises that content of the messages includes specific linguistic data.

Optionally, the pre-set condition comprises that the content of the messages is related to content of a historical message sent by the user.

Optionally, the pre-set condition includes that the content of the messages includes a label of the user.

It should be noted that for the features in this embodiment, reference may be made to the related descriptions for the related features in the embodiments discussed in the description of FIGS. 1, 2, 3A, 3B, and 4, and details are not described herein again.

It can be seen that for received important messages that are sent to a user, when a group conversation interface is active and if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

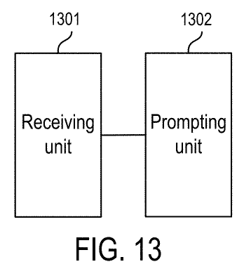

FIG. 13 is a block diagram illustrating a message displaying apparatus according to some embodiments of the disclosure. This embodiment is a device embodiment corresponding to the embodiments discussed in the description of FIG. 12. In the illustrated embodiment, the apparatus may be applicable to an instant messaging tool configured on a smart terminal. The apparatus includes a receiving unit (1301) a prompting unit (1302).

The receiving unit (1301) is configured to receive important messages sent to a user, wherein the user is a user logging into the instant messaging tool on the smart terminal, and the important messages are messages meeting a pre-set condition.

The prompting unit (1302) is configured to do the following: when a group conversation interface is active, display a message prompt indicator on the group conversation interface if an unread message exists among the important messages, wherein the group conversation interface is an interface for conversations between the user and a plurality of other users, and the message prompt indicator is used to prompt the user for an unread message.

It should be noted that for the features in this embodiment, reference may be made to the related descriptions for the related features in the embodiments discussed in the description of FIG. 12, and details are not described herein again.

It can be seen that for received important messages that are sent to a user, when a group conversation interface is active and if an important unread message is found, a message prompt indicator may be displayed on the group conversation interface. Such a method can effectively help the user to determine important messages from a large number of messages on the group conversation interface and a prompt for the user can be provided, thereby reducing the situation where the user misses an important message and improving the user experience.

A person of ordinary skill in the art may understand that all or part of the steps for implementing the method embodiments above may be completed by a program instructing relevant hardware. The foregoing program may be stored in a computer-readable storage medium; and when executed, the program may perform the steps of the method embodiments above. The foregoing storage medium may be at least one of the following media: a read-only memory (ROM), a RAM, a magnetic disk, an optical disk, and other media that can store program codes.

It should be noted that the embodiments in this specification are described in a progressive manner. For the same or similar parts in the embodiments, reference may be made to each other; and each embodiment focuses on the differences one embodiment has from other embodiments. Specifically, because the device and system embodiments are similar to the method embodiments, the description for the device and system embodiments is relatively concise. For the relevant parts among of these embodiments, reference may be made to the descriptions in the method embodiment sections. The apparatus and system embodiments described above are merely exemplary. The units described as separate parts may or may not be physically separated; and the parts shown as units may or may not be physical units, which may be located in one place or may be distributed onto a plurality of network units. The purpose of the solutions of the embodiments can be achieved by selecting part or all of the modules according to actual requirements. Persons of ordinary skill in the art can understand and implement them without creative efforts.

The above descriptions are merely specific implementations of the disclosed embodiments and the scope of the disclosed embodiments is not limited thereto. Variations or replacements that any person skilled in the art can easily conceive of within the technical scope of the disclosed embodiments should be covered by the scope of the disclosed embodiments.

What is claimed is:

1. A method comprising:
receiving, at a client device, messages for display on an instant messaging tool installed on the client device;
displaying, on the client device, the messages in a conversation interface of the instant messaging tool;
identifying, by the client device, an important message in the messages;
displaying, by the client device, a message prompt indicator in response to detecting the important message;
expanding, by the client device, a message viewing area in a partial area of the instant messaging tool in response to detecting an operation executed on the message prompt indicator; and
displaying, by the client device, the important message in the message viewing area.

2. The method of claim 1, the receiving messages comprising receiving messages prior to a user of the client device logging into the instant messaging tool.

3. The method of claim 1, the identifying an important message in the messages comprising determining, by the client device, that the important message meets a pre-set condition, the pre-set condition comprising one or more of:
content of the important message including specific linguistic data;
content of the important message being related to content of a historical message sent by a sender of the important message;
content of the important message including an identifier of a user of the client device;
a sender of the important message matching an identified sender; and
a sender of the important message having a predetermined relationship with the user of the client device.

4. The method of claim 1, the detecting an operation executed on the message prompt indicator comprising detecting one or more of a double click, long press, sliding operation, or multiple successive touches or taps.

5. The method of claim 1, the expanding a message viewing area in a partial area of the instant messaging tool comprising resizing, by the client device, the message viewing area and the conversation interface so that the conversation interface is reduced in size.

6. The method of claim 5, the resizing the message viewing area comprising extending, by the client device, the message viewing area outward from one side of the client device.

7. The method of claim 6, the extending the message viewing area outward from one side of the client device comprising one or more of:
extending, by the client device, the message viewing area downward from an area displaying a conversation title of the conversation interface;
extending, by the client device, the message viewing area rightward from a left border of the conversation interface; and
extending, by the client device, the message viewing area leftward from a right border of the conversation interface.

8. The method of claim 5, the resizing the message viewing area comprising positioning, by the client device, the message viewing area at a location indicated by a drag operation.

9. The method of claim 1, the displaying the important message in the message viewing area further comprising displaying, by the client device, one or more of a clear button and scroll bars.

10. The method of claim 1 the displaying the important message in the message viewing area further comprising displaying, by the client device, the important message in a different style and one or more messages displayed in the conversation interface.

11. An apparatus comprising:
a processor; and
a storage medium for tangibly storing thereon program logic for execution by the processor, the stored program logic comprising:
logic, executed by the processor, for receiving messages for display on an instant messaging tool executed by the processor,
logic, executed by the processor, for displaying the messages in a conversation interface of the instant messaging tool,
logic, executed by the processor, for identifying an important message in the messages,
logic, executed by the processor, for displaying a message prompt indicator in response to detecting the important message,
logic, executed by the processor, for expanding a message viewing area in a partial area of the instant messaging tool in response to detecting an operation executed on the message prompt indicator, and
logic, executed by the processor, for displaying the important message in the message viewing area.

12. The apparatus of claim 11, the logic for receiving messages comprising logic, executed by the processor, for receiving messages prior to a user of the client device logging into the instant messaging tool.

13. The apparatus of claim 11, the logic for identifying an important message in the messages comprising logic, executed by the processor, for determining that the important message meets a pre-set condition, the pre-set condition comprising one or more of:
content of the important message including specific linguistic data;
content of the important message being related to content of a historical message sent by a sender of the important message;
content of the important message including an identifier of a user of the client device;
a sender of the important message matching an identified sender; and
a sender of the important message having a predetermined relationship with the user of the client device.

14. The apparatus of claim 11, the logic for detecting an operation executed on the message prompt indicator comprising logic, executed by the processor, for detecting one or more of a double click, long press, sliding operation, or multiple successive touches or taps.

15. The apparatus of claim 11, the logic for expanding a message viewing area in a partial area of the instant messaging tool comprising logic, executed by the processor, for resizing the message viewing area and the conversation interface so that the conversation interface is reduced in size.

16. The apparatus of claim 15, the logic for resizing the message viewing area comprising logic, executed by the processor, for extending the message viewing area outward from one side of the client device.

17. The apparatus of claim 16, the logic for extending the message viewing area outward from one side of the client device comprising one or more of:
logic, executed by the processor, for extending the message viewing area downward from an area displaying a conversation title of the conversation interface;
logic, executed by the processor, for extending the message viewing area rightward from a left border of the conversation interface; and
logic, executed by the processor, for extending the message viewing area leftward from a right border of the conversation interface.

18. The apparatus of claim 15, the logic for the resizing the message viewing area comprising logic, executed by the processor, for positioning the message viewing area at a location indicated by a drag operation.

19. The apparatus of claim 11, the logic for displaying the important message in the message viewing area further comprising logic, executed by the processor, for displaying one or more of a clear button and scroll bars.

20. The apparatus of claim 11, the logic for displaying the important message in the message viewing area further comprising logic, executed by the processor, for displaying the important message in a different style and one or more messages displayed in the conversation interface.
